(19) United States
(12) Patent Application Publication
(10) Pub. No.: US 2006/0253328 A1
(43) Pub. Date: Nov. 9, 2006

(54) Targeted advertising using verifiable information

(76) Inventors: Ujjal Kohli, Saratoga, CA (US); James T. Morris, San Francisco, CA (US); Rajat Shroff, Redwood Shores, CA (US); Shaukat Shamim, Santa Clara, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/418,767

(22) Filed: May 5, 2006

Related U.S. Application Data
(60) Provisional application No. 60/678,657, filed on May 6, 2005.

(51) Int. Cl. G06Q 30/00

(52) U.S. Cl. 705/14

(57) ABSTRACT

A system and a method to match advertisement requests with campaigns using targeting attributes, and campaigns are selected for fulfillment of the advertisement request according to a priority algorithm. The targeting uses end user information that is verifiable, and which the user has granted permission to use, improving the granularity and accuracy of the targeting data. The algorithm includes load balancing and campaign state evaluation on a per campaign, per user basis. The algorithm enables control over the frequency and number of exposures for a campaign, optimizing the advertising both from the perspective of the user and the advertiser.

### CROSS REFERENCE TO RELATED APPLICATIONS

This application claims the benefit of U.S. Provisional Patent Application No. 60/678,567, filed May 6, 2005, entitled “Advertising in Mobile Wireless Networks,” which is incorporated herein in its entirety by reference.

This application is related to U.S. patent application Ser. No. ______, filed May 5, 2006, entitled “Optimized Advertising Fulfillment,” by James T. Morris, et al., which is incorporated herein in its entirety by reference.

### BACKGROUND

1. Field of Art

The present invention generally relates to the field of advertising, and more specifically, to advertising targeting and fulfillment of advertising.

2. Description of the Related Art

Advertising targeted to an appropriate potential customer base generally is considered more desirable than untargeted or broadcast advertising. However, some media, e.g., broadcast and radio media, have limited targeting capabilities. Internet advertising has some ability to target advertising, however few publishers know their users outside the context of a cookie. Further, the use of cookies and similar information provides information about the associated computer, not the user. Even when data is requested from a user, generally there is no way to know if the data input is accurate.

Thus, most advertising uses a basic priority system. As a result of the conventional priority system, the end user sees a lot of advertising “clutter” caused by irrelevant broadcast advertisements. Advertisers also suffer under this system, e.g., by spending money for advertising in which the end user is uninterested.

It is known generally that both overexposure and underexposure of a user to a given advertisement is undesirable. Therefore, controls are needed on the frequency and number of exposures for a particular advertisement to an end user. However, the factors above that make targeting difficult in various media types often prohibit publishers from monitoring individual user's exposure to advertising content.

Hence, there is a need for a system and a method for providing targeted advertising using verifiable information and for optimizing advertisement fulfillment.

### SUMMARY

In one embodiment, advertisement requests originating at end users are matched with campaigns with targeting attributes aligned with parameters of the advertisement requests, and campaigns are selected for fulfillment of the advertisement requests according to a priority algorithm. As used herein, the term advertisement request refers to information indicating one or more available location(s) for one or more advertisement(s) to be placed, the information received, e.g., with a content request from an end user. Information in the advertisement request includes or provides a means for obtaining parameters including end user information and other targeting attributes. The end user information is information about the user that is verifiable and that the user has granted permission to use. Thus, the targeting data is extensive and more likely to be accurate with respect to the end user.

The targeting data then is used for prioritizing advertising campaigns according to an algorithm. The algorithm includes load balancing of advertisements across campaigns and user experiences and an evaluation of the state of a campaign, with respect to the requesting user according to one embodiment, e.g., what advertisements of the campaign the end user has already seen and when the advertisements were seen. The algorithm considers the above and other factors on a per campaign, per user basis, relying on stored user history. As a result, the frequency and number of exposures for a campaign are controlled for the user. Thus, fulfillment of the advertisement request is optimized both from the perspective of the user, who sees a variety of relevant advertisements spaced for an effective user experience, and the advertiser, who gets an advertisement shown to a narrowly-targeted audience.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

Figure (FIG.) 1 illustrates a system for practicing the present invention according to one embodiment of the present invention.

FIG. 2 is a flowchart illustrating a method of providing targeted advertising according to one embodiment of the present invention.

FIG. 3 is a flowchart illustrating a method of optimizing fulfillment of advertisement requests according to one embodiment of the present invention.

FIG. 4 illustrates a process flow between the modules and entities for practicing the present invention according to one embodiment.

FIG. 5 illustrates an example of a hyperdimensional array according to one embodiment.

FIG. 6 illustrates a user interface for selection of segments of users according to one embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Generally, the disclosed embodiments describe a system and a method for providing targeted advertising and optimizing fulfillment of advertisement requests. Advertisement requests are matched with campaigns with targeting attributes aligned with parameters of the advertisement requests, and campaigns are selected for fulfillment of the advertisement request according to a priority algorithm. An advertising campaign, as the term is used herein, refers to a series of advertisements that share a single idea and/or theme. Advertising campaigns may appear in different media across a specific time frame according to one embodiment. The algorithm includes load balancing and campaign state evaluation with respect to the requesting user. The targeting is directed at individual users according to one embodiment.

The present invention is described in the context of media advertising according to one embodiment. Media encompasses a broad range of digital interactive media and other media types. One characteristic of some media types is that they exhibit dynamic motion which may occur in direct response to a user action according to one embodiment. A media advertisement is a media item that promotes a particular product, service or other event. Media advertisements may include, but are not limited to, video clips, interactive games or videos, interstitial web pages or videos, Flash files, wallpapers, audio clips, banner advertisements, and instant messages. Rich media advertisements may include functionality that starts and stops the advertisement. The start and stop of an advertisement may be initiated by a user or may be controlled by a device.

The present invention is described in the context of brand advertising according to one embodiment, which requires a greater knowledge of who is the end user. Brand advertising is commonly defined as advertising that creates a distinct favorable image that customers associate with a product when making buying decisions. However, the system and methods described herein also are applicable to transactional advertising, which requires a greater knowledge of what the user is doing. Transactional advertising is generally considered more action-oriented, with an eye toward motivating behavior.

Various pricing models are used between the entities described herein according to various embodiments, for example cost per impression and cost per interaction. In the cost per impression model, an advertiser pays a fixed amount each time an advertisement is sent to an end user according to one embodiment. An impression is defined as an advertisement delivered according to predetermined specifications according to one embodiment. Cost per interaction is applicable to advertisements with which an end user may interact. For example, an interactive advertisement may provide for interaction with the user, e.g., by pressing certain buttons on the user's device associated with various choices.

Reference first is made to figure (FIG.) 1, which illustrates a system 100 for practicing the present invention according to one embodiment of the present invention. The system 100 includes, in one embodiment, an inventory module 105, a campaign module 110, a fulfillment module 115, a delivery module 120, and data storage 125. In one embodiment, the inventory module 105, campaign module 110, fulfillment module 115, and data storage 125 are part of an advertising services provider 155. Although some examples are described herein in the context of mobile wireless, the systems and methods described herein can be used with various media formats according to various embodiments.

The inventory module 105 provides inventory management functionality for available advertising space. The inventory module 105 has an interface accessible by one or more service providers 130, for ongoing auditing and monitoring of advertising inventory as described herein.

The campaign module 110 provides campaign management functionality for reserving and purchasing advertising. The campaign module 110 has an interface accessible by one or more advertising agencies 135 for ongoing monitoring, reservation, and purchase of campaigns as described herein.

The fulfillment module 115 provides fulfillment functionality for the present invention. The fulfillment module 115 receives requests from the delivery module 120, matches the requests to available advertisements based on stored data, and sends the name(s) of one or more selected advertisement(s) to the delivery module 120.

The fulfillment module 115 matches stored advertising inventory to advertisement requests, using advertisement selection data sent with the advertisement request, verifiable end user information, and stored campaign information. The fulfillment module 115 also performs various management, monitoring, security and control features to ensure that correct advertisements are provided to the delivery module 120, and to maintain a record of fulfillment information.

One or more delivery modules 120 act as intermediaries between the end user 140 and the fulfillment module 115. The delivery modules 120 are embodied in software according to one embodiment, which is located at the service provider 130, a third party content provider, and/or may be located at the advertising services provider 155, as indicated by the dotted line between the advertising services provider 155 and the delivery module 120. The delivery module 120 also may provide advertisement selection (whether or not so directed by the fulfillment module), advertisement insertion, caching, logging and advertisement delivery functions. In one embodiment, the delivery module 120 is hosted by an advertising services provider 155.

The delivery module 120 includes a delivery engine 145, a media interface 150, and optionally a cache 160. The delivery engine 145, according to one embodiment of the present invention, receives information about the end user who has submitted an advertisement request, e.g., a mobile wireless user advertisement request in conjunction with a request for a video clip, and forwards this information to the fulfillment module 115. The delivery engine 145 receives matching advertisement names from data storage 125 via the fulfillment module 115 according to one embodiment. The advertisements are provided by a third-party, hosted by the advertising services provider 155, and may be cached on the delivery module 120, for example, if the advertisement source is remote from the advertising services provider 155.

The media interface 150 is a hook on the delivery module 120 that allows advertising campaigns to be served with media content. Content, as used herein, refers to media other than advertising. The media interface 150 is the component of the delivery module 120 in direct communication with the end user 140 device. The media interface 150 receives the advertisement requests from end users 140, and sends the fulfilled advertisement requests and responses to the end user 140.

The cache 160 is a standard cache of small, fast memory according to one embodiment, e.g., for holding data for local access. The cache 160 may include, for example, advertisements for streaming with content in response to an advertisement request.

The data storage 125 may be a relational database or any other type of data storage that stores the data used by the modules, and may be stored in various formats, e.g., in system memory. For example, the data includes verifiable user information, user history, content metadata, campaign data, and advertisement data according to one embodiment. Verifiable user information includes demographic information, advertisement preference information, and/or behavioral information according to various embodiments. In another embodiment, separate data storages are used for different data types, such as user history and campaign data.

The above modules need not be discrete software modules and one or more functions of the noted modules may be integrated together. The software configuration shown is meant only by way of example; other configurations are contemplated by and within the scope of the present invention.

Advertising agencies 135 and service providers 130 interact with the system 100 as described above. An advertising agency 135 acts as an agent for a producer of goods or services devoted to developing and placing advertising. A service provider 135 establishes a relationship with the end user 140, e.g., for providing content delivery services to the end user 140 and billing there for. One or more end users 140 are the ultimate destination for the advertising described herein. In one embodiment, the end user 140 is the user of a mobile wireless device, e.g., a mobile phone.

The various modules and system components communicate via a network in one embodiment. The network may be a wired or wireless network. Examples of the network include the public networks, private networks, Internet, an intranet, a cellular network, or a combination thereof, or other system or method enabling digital communication between two or more computing systems. A network interface and a network communication protocol provide access to a network and other computers according to one embodiment, such as other user computers 205 or third party computers 215, along with access to the Internet, via a TCP/IP type connection, or to other network embodiments, such as a LAN, a WAN, a MAN, a wired or wireless network, a private network, a virtual private network, or other networks.

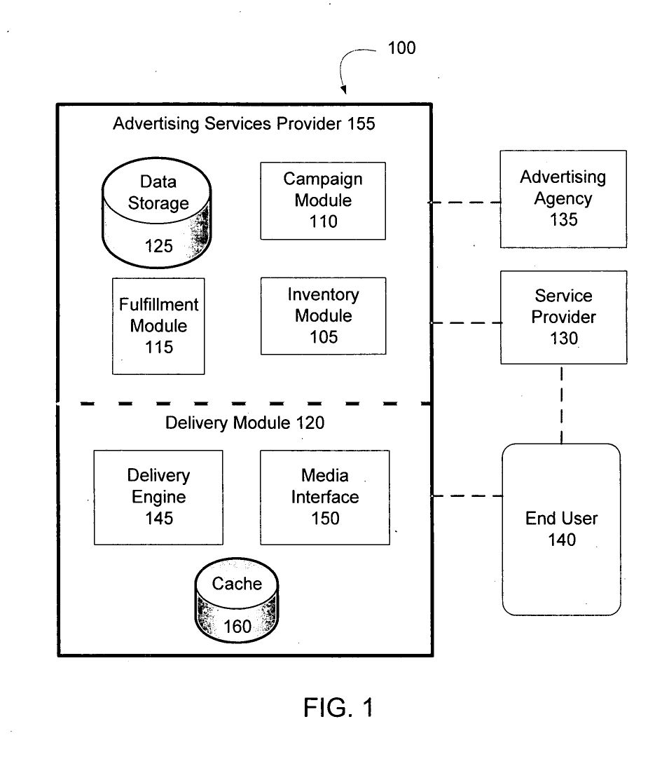

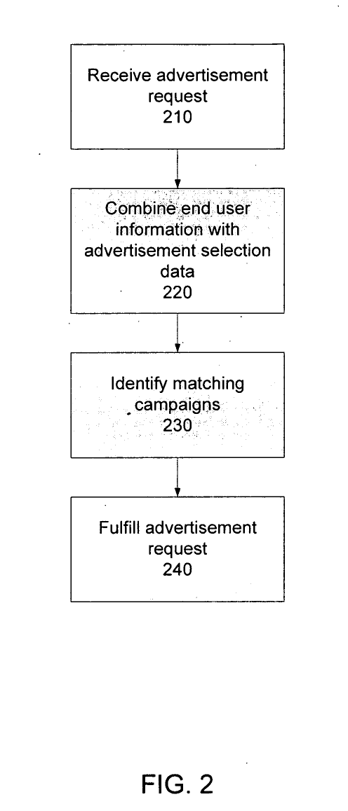

Reference now is made to FIG. 2, which is a flowchart illustrating a method of providing targeted advertising according to one embodiment of the present invention. In general, service providers have information about users that may be used to provide advertising that is more narrowly targeted to individuals or small groups of users. One goal of such targeting is to improve the accuracy of a targeted advertisement. This aspect of the present invention is advantageous to both the user, who receives advertising that is more relevant, and the service provider, because advertisers are willing to pay more to advertise their products or services if they know that the people who will receive the advertisements are likely consumers of their products or services. In addition, service providers 130 benefit by selling advertising inventory against specific types of users, not just content. In the context of transactional advertising, this aspect of the present invention is advantageous because it increases the likelihood that the end user 140 will act on the advertisement.

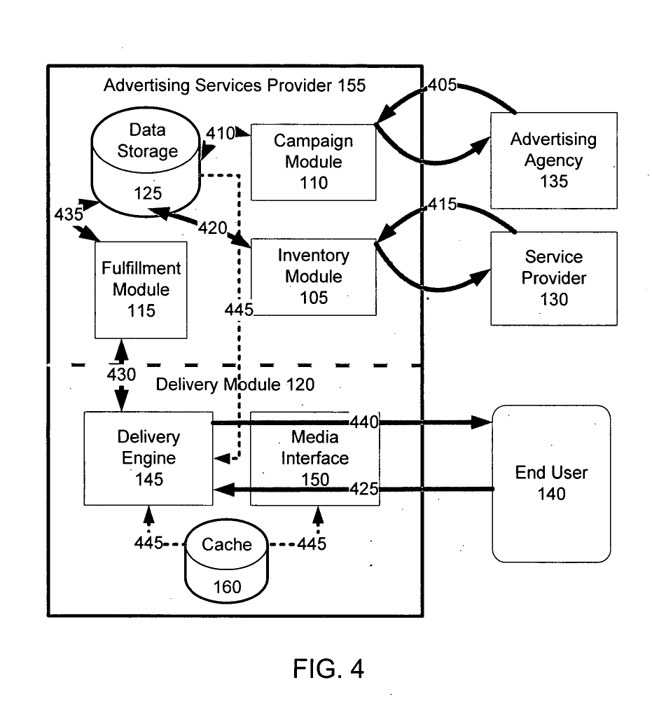

The method according to one embodiment is performed in the context of a process flow between entities including an advertising services provider 155, one or more service providers 130, and one or more advertising agencies 135, e.g., as described in conjunction with FIG. 4. The steps of the method are performed by an advertising services provider 155 according to one embodiment.

Initially, an advertisement request is received 210 comprising advertisement selection data. Initially, an end user 140 requests a multi-media file, e.g., a video clip, that is to be served to the end user 140, e.g., from a delivery module 120 according to one embodiment of the present invention. The delivery module 120 recognizes the advertisement request and provides it to the fulfillment module 115, which receives 210 the advertisement request. In one embodiment, the advertisement selection data or a portion thereof is stored for use according to other aspects of the method. According to one embodiment, the advertising is targeted to an individual end user.

In one embodiment, the advertisement selection data received with the advertisement request includes user identification information, time of request, content identification information, and requesting device type. Advertisement selection data also may include requesting or receiving device location information, which can increase relevancy of delivered advertisements based on user location according to one embodiment. Advertisement selection data is one type of data that is used for providing targeted advertising. For example, the time of day and the location of the user when the request is made may be relevant to which advertisements should be targeted at a particular user.

Next, end user information is combined 220 with the advertisement selection data. End user information is another type of data that is used for providing targeted advertising according to one embodiment. In one embodiment, end user information is identified using the advertisement selection data. For example, user identification information takes the form of a user ID according to one embodiment; end user information is associated with the user ID, e.g., as stored in data storage 125. In one embodiment, end user devices are associated with a unique identification number. One example is a mobile telephone associated with the mobile number or a number including the mobile number.

Combining 220 the data includes in one embodiment mapping the advertisement selection data to data stored in data storage 125, for example information about the specific content type, content category, media type, and/or advertisement request location within the content may be keyed off of the content identification information from the advertisement selection data.

End user information comprises, in one embodiment, verifiable information that the end user has granted permission to use. The information is verifiable by various processes according to the embodiments, some of which are described in greater detail below. For example, the service provider 130 may have the access to the information, e.g., through the provider's relationship with the end user 140, someone associated with the end user, or via a third party. The use of verifiable information enhances the accuracy of the end user data because the information can be verified separate from such data as entered by an end user 140. According to one embodiment, the service provider 130 provides end user information according to one embodiment. Since service providers 130 maintain a service and billing relationship with end users 140, they have access to information about end users 140 that can be used to better target advertisements to mobile users as discussed further herein. For example, the service provider 130 may gather the data when, e.g., a user applies for a new account, for which they will be billed for service rendered. However, it may be uncomfortable or even illegal in some cases to use end users' verifiable data is used without permission.

End users 140 have a reasonable expectation that their personal information will be used only by the service provider 130, and advertisers usually are seen as outside parties. Thus, expressly receiving permission to collect and use personal data allows service providers 130 to gather valuable targeting information and usage characteristics to deliver a better user experience according to one embodiment. In addition, verifiable information may also be used for crafting the actual service according to one embodiment, for example, by moving preferred content choices to the top of a catalog.

In one embodiment, the end user 140 grants to the service provider permission to use end user information the service provider 130 already has access to via the provider-user relationship, for example age, gender, and zip code, via agreement to terms and conditions. For example, the service provider 130 may have access to the information because of the trusted relationship between the end user 140 and the service provider 130, or because it has been provided to the service provider 130 by a third party, e.g., as a result of a credit check. In another embodiment, the end user 140 grants to the service provider permission to use end user information that the service provider 130 does not already have access to, i.e., information that requires data entry on the part of the end user 140. According to yet another embodiment, the end user has explicitly disclosed the end user information, e.g., to a service provider or a third party.

One embodiment includes information about more than one user. An example is the use of family plans, which are known, for example, in the mobile wireless art. In this example, when a new family member is added to a plan, a query requests information about the new member, which is verifiable by the primary family member/user, e.g., the initial end user.

In one embodiment, the advertising agency 135 does not have access to the end user information itself. Instead, the information is maintained by a third party, e.g., by the advertising services provider 155, such that the information can be used for targeting without being revealed to the advertiser 135. In another embodiment, the end user 140 chooses how much and what information is shared with advertisers 135.

A non-exhaustive list of end user information includes age, gender, income, education-level, home zip code (or region), work zip code (or region), marital status, number of children, user-described attributes, number of people in household, credit history, service usage, billing history. Service providers 130 are the only party likely to have access to this expanse of targeting information. Service providers 130 know each end user 140—at a minimum by their billing information—and gather data covering every aspect of how subscribers use their phones. End user information includes, according to one embodiment, user-provided preferences. For example, if an end user is of legal drinking age, alcohol advertisements might be targeted to the end user. However, if the end user does not drink, e.g., then the user could indicate such a lack of interest in seeing advertisements for alcohol products.

In one embodiment, advertising relevance can be further increased for advertisements that include means for a user to indicate interest, e.g., by clicking on a link in the advertisement. Some advertisements include one or more interactive elements, e.g., including information regarding how the user can obtain additional information about the product or service. Interactive elements provide information about actions the end user 140 may take to obtain additional information about the product or service according to one embodiment. For example, for a given advertisement, a user 140 may press a button to request a brochure about a product or service offered, press another button to schedule a demonstration of a product or service, press yet another button to find a local retailer of the product or service, schedule a test drive, and/or press a button to request additional information about the product or service via the end user device, e.g., a video about the product or service. In another embodiment, the length of time that an end user 140 views an advertisement can be tracked as a proxy of relevance.

After combining the data, one or more campaigns are identified 230 with targeting attributes aligned with the combined end user information and advertisement selection data. The combined data represent a set of parameters for matching to campaigns according to one embodiment. In one embodiment, initially all campaigns that satisfy the parameters are considered as possibilities for filling the request. From the stored parameter and campaign information, mapping or linking functionality is provided between the two types of information.

The specificity with which the parameters are matched to available campaigns varies according to a variety of embodiments. In one embodiment, end users 140 and/or campaign inventory are separated into segments. Thus, campaigns are selected for the end user based on a token, or on other user attributes that identify a segment to which the user belongs. In one embodiment, segments are divided into subsegments. In another embodiment, end users 140 and/or campaign inventory is divided into microcells, which represent a narrow set of end user attributes. Campaign targeting criteria and end user parameters are thus aligned. Segments and microcells are described in greater detail below.

In one embodiment, the matching 230 captures campaigns that match any attribute associated with the parameters. For example, an advertisement request from an end user who is male, aged, 18-24, and watching a sports clip would match up to the following campaign groupings (e.g., segments or microcells): 18-24/male/sports, 18-24/male, 18-24/sports, 18-24, male/sports, male, sports, and run of network (i.e., anyone).

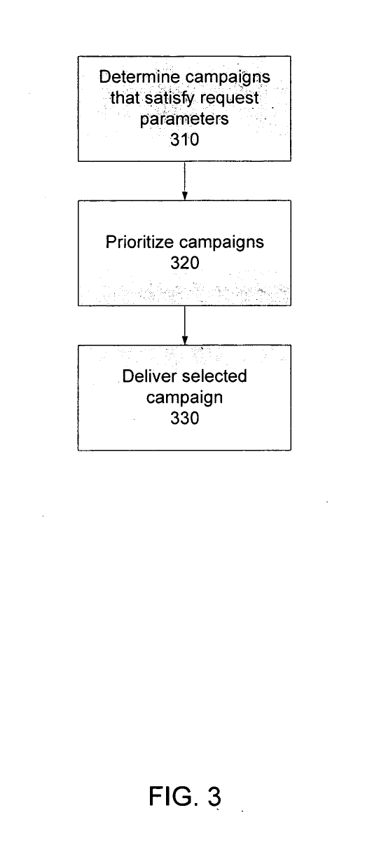

After identifying 230 matching campaigns, the advertisement request is fulfilled 240 according to a priority algorithm. The fulfillment algorithm varies according to various embodiments, one embodiment of which is described in conjunction with FIG. 3. The advertisement ultimately reaches the end user 140 from whom the advertisement request originated.

Segmenting

As referenced above, the specificity with which parameters are matched to campaigns varies. In one embodiment, end users and/or campaign inventory are separated into segments. Segments are updated as profiles of end user 140 change or additional end users 140 are added to the pool according to one embodiment.

In one embodiment, end users 140 are grouped into segments based on specific attributes of the users 140. The segments may be defined to optimize their value to potential advertisers by grouping the users into segments that advertisers are familiar with and can easily identify as being relevant to their product or service. The attributes used to group users include end user information and advertisement selection data as described above according to one embodiment, and may include the psychography of the user. Psychography includes information about previous behavior of the user, such as the likelihood of the user to be an early adopter of technology and the spending habits of a user. For example, users who have interacted with advertisements in the past may be grouped according to this information. Similarly, users who have shown a propensity to spend large sums of money on technology or other purchases may be grouped accordingly. In one embodiment, lifestyle information also is used to define segments. In this example, the lifestyle information is determined from a third-party database of information from which lifestyle information can be determined from end user 140 information such as zip code and age, according to one embodiment.

Segments may be statically or dynamically defined, by service providers 130, advertising agencies 135, or the advertising services provider 155. When statically defined, segments are determined based on specific attributes of the users according to one embodiment. The static segments are presented to an advertiser 135 as options from which to choose. The advertiser 135 may choose one or more segments that target those at whom the advertiser would like to target their advertisements. If the segments are standardized across multiple service providers 130, advertisers 135 are provided with easily recognizable segments from which to choose, easing inventory purchasing.

When dynamically defined, the advertiser 135 may define the characteristics or attributes of the users they would like to target according to one embodiment. In this example, a user may be part of multiple dynamic segments defined by the advertisers 135. The advantage of dynamic segments is that it allows the advertiser 135 to specify with greater granularity the individuals the advertiser would like to target. The service provider 130 or advertising services provider 155 providing the segments may be able to charge more for dynamic segments than for static segments.

One skilled in the art will recognize that there are a number of ways to identify one or more segments to which the user may belong. In one embodiment, the service provider may maintain a database or list that maps each user to one or more segments. The determination of which segment a user belongs may be examined dynamically and changes may be made to a user's classification based on changes in the way segments are defined or based on changes in the user's verifiable information or psychographic information. In another embodiment, the segment determination may be made in real time at the time an advertisement request is received.

In one embodiment of the invention, a token may be assigned to each user 140 identifying the segment to which the user 140 belongs. Using a token to identify the segment to which the user 140 belongs provides privacy protection to the user. In another embodiment, the token or other identifier may be sent to the user 140. The user 140 may store the token and transmit the token along with each advertisement request. The service provider may periodically update the token as stored with the user 140 upon changes to the segment definitions and/or changes in the demography or psychography of the user 140.

In one embodiment of the invention, one or more of the segments may be further subdivided into sub-segments. A sub-segment may be used to further narrow the type of individual targeted by the individual. When using sub-segments, the token or other identifier used to identify, a segment to which a user belongs may also include a sub-segment identifier to identify the sub-segment to which the user belongs.

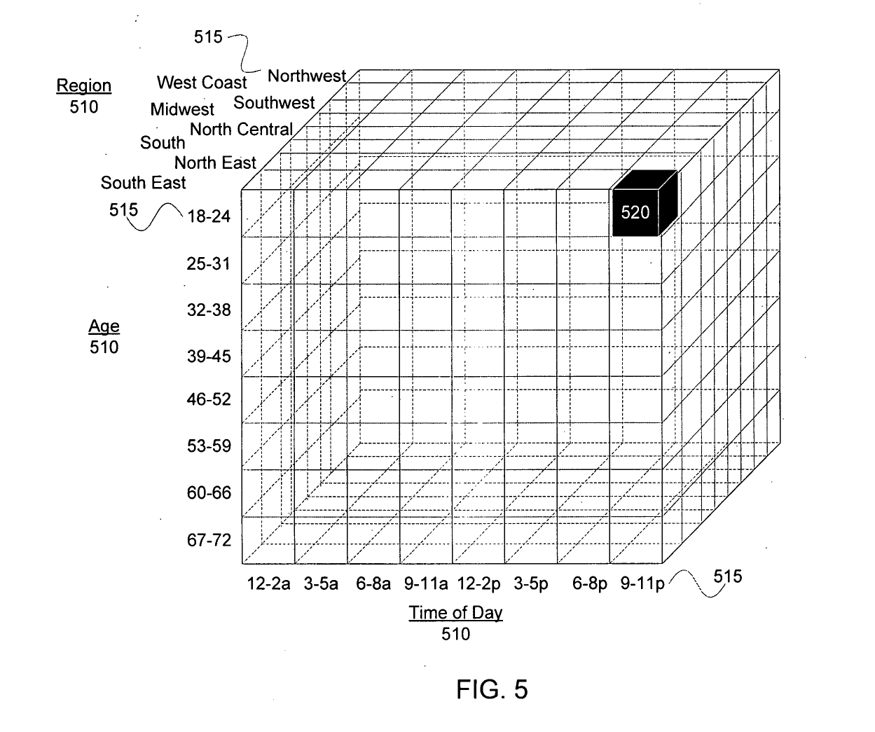

In another embodiment, end users and/or campaign inventory are divided into microcells, which represent a narrow set of attributes. Conceptually, a microcell is a single element in a hyperdimensional array. An example of one embodiment of a hyperdimensional array 500 is shown in FIG. 5. In this example, three dimensions are shown for simplicity of illustration, but any one or more dimensions are possible. The array 500 includes a plurality of intersecting dimension planes 510, e.g., age, time of day, and region as shown. Dimensions may be advertisement selection data, end user information, and/or other attributes according to one embodiment. Each dimension plane 510 includes a plurality of attribute rows 515, e.g., 18-24, 25-31, 32-38, etc. for the age plane 510. The attribute rows 515 intersect to define a plurality of contiguous, non-overlapping microcells 520. The darkened microcell 520, e.g., represents the intersection of age 18-24, time 9-11 p, and the South East region. Each advertisement request fits into a microcell 520 defined by a unique intersection of the attribute rows 515.

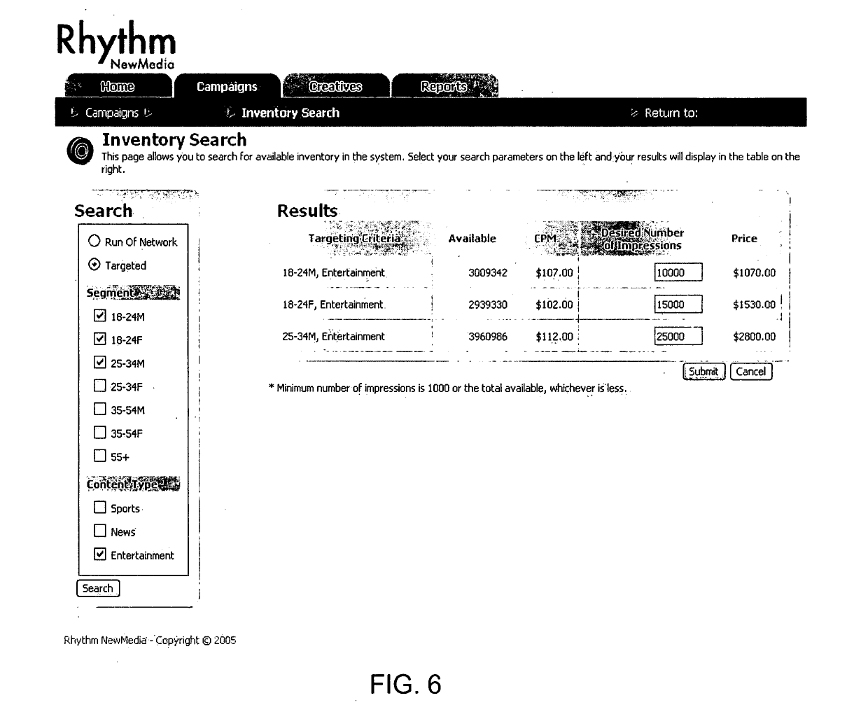

Advertising can be purchased tailored as narrowly as to the single microcell 520 in one embodiment, or rows 515 of the array 500 can be combined along various planes 510 to form desired groupings. In another embodiment, advertising can be purchased by segments. Advertisers choose segments and/or microcells via a user interface for this purpose according to one embodiment. An example of such a user interface is shown in FIG. 6. In the example shown, available targeting criteria include age, gender, and content type.

Reference now is made to FIG. 3, which is a flowchart illustrating a method of optimizing fulfillment of advertisement requests according to one embodiment of the present invention. A number of different methods and devices may be employed to identify an appropriate advertisement campaign, to match the campaign to an end user, and to deliver the campaign to the end user according to various embodiments of the present invention. The following illustrates one such method.

Initially, a plurality of reserved campaigns is determined 310 that satisfy parameters associated with an advertisement request according to one embodiment. This process is similar to the matching step 230 described above in conjunction with FIG. 2. In one embodiment, the advertising services provider 155 matches up the reserved campaigns with the advertisement request parameters.

According to one embodiment, the campaigns are reserved against various segments or microcells as described herein. Using various methods of predicting the number of advertising requests according to targeting criteria as defined by the advertiser, campaigns are reserved using an advertising services provider 155 according to one embodiment.

Campaign reservations are made, according to one embodiment, via a system that monitors and audits advertisements and campaigns. Advertisement request history information is presented to the advertiser 135 and may assist the advertiser in determining how to allocate advertisements between various segments and/or microcells. Collecting this information also is valuable to the service provider 130, as the information may reveal patterns of behavior.

Forecasting informs the reservation system according to one embodiment. Usage data for delivered advertisements and fulfilled advertisement requests is used to predict the number of future advertisement requests for segments or microcells of advertisements. This information helps the service provider 130 optimize their inventory by providing a model to predict how many and what kind of advertisement requests will be made by end users 140.

In some media formats, such as mobile wireless, the on demand nature of the service makes it hard to predict the number of advertisements that will be served on any given time period. Fluctuations may occur in recognizable patterns, such as serving more media to users on Monday than on Sunday, or may be based on arbitrary factors, such as an increase in demand to view game highlights following a particular sporting event. In addition, the amount of media requested by users may vary greatly from day to day. Such variations may make it more difficult to determine how many advertisement requests to allocate to the various advertising campaigns.

Monitoring and auditing of advertisements are used according to one embodiment to make predictions about the number and type of advertisement requests at a given time. By tracking the number of impressions, defined as an advertisement delivered according to predetermined specifications, an estimate is made as to the number of advertisements that will be sent out in a given day. By creating models that monitor trends based on the audit information, predictions about how many advertisements will be requested over a given period of time may be determined. These predictions, or forecasts, may be made at the macro level down to each segment or microcell according to various embodiments. The predictions then can be updated with the advertisement request fulfillment data. Monitoring trends in this manner provides a more accurate view of what and how much advertising to sell or reserve, allowing a closer fit between advertising campaigns held in inventory and advertisement requests as they are received. For example, an impression count for a campaign is incremented as advertisement requests are fulfilled, according to one embodiment. The impression count informs the forecasting model. The goal of the above monitoring and auditing in this manner is to optimize the number and relevance of advertisements for a user 140 within a period of time.

After campaigns that meet request parameters are determined, the campaigns are prioritized 320 according to an algorithm according to one embodiment. For example, the algorithm includes load balancing and campaign state evaluation with respect to an end user associated with the advertisement request according to one embodiment.

Load balancing is the distribution of advertising fulfillment among available campaigns according to one embodiment. For example, load balancing may include definitive parameters and weighing of conflicting factors. Maximum impressions for a time period is a definitive parameter according to one embodiment. Campaigns may include rules placing a limit on the number impressions for the campaign over a given time period, e.g., an hour, a day, or a week. Campaign variety and value are weighed as conflicting factors according to one embodiment. For example, to provide an optimal user experience, a variety of advertisements should be shown. However, some advertisers pay more to have their advertisements shown a greater number of times and/or to particular audiences, and financial motivations may make higher value advertisements more inclined to get placed according to various embodiments. Thus, a best fit model is applied in one embodiment to balance variety and value. In one embodiment, load balancing does not entail equal distribution of advertisements among all reserved campaigns.

Campaign state evaluation is a consideration of the readiness of a campaign for fulfillment of an advertisement request according to one embodiment. Readiness is a dynamic determination, based on recent end user 140 behavior. Campaign state according to one embodiment includes consideration of the amount of time that has elapsed since the last advertisement in the campaign and whether the campaign is in progress with respect to a multiple-advertisement campaign. For example, if a campaign has three advertisement parts, that campaign will be ready sooner than a single-advertisement campaign, e.g., to increase the likelihood that all three parts can be shown and provide a greater variety of advertisements to the end user 140. These time-dependent readiness thresholds are adjusted dependent on user viewing habits according to one embodiment, e.g., the time between advertisements may be decreased for heavy users. In addition, some time-independent readiness thresholds are used according to one embodiment, e.g., a buffer of other advertisements between advertisements of a campaign.

End user history is maintained in data storage 125. As a result, load balancing and campaign state are determined on a per user basis according to one embodiment. This aspect of the present invention allows for greater specificity and more succinct targeting. Since the end user data is provided by the service provider 130, if no user history or verifiable information is available for a particular user, content-based targeting and/or run of network advertisements can be run until such information is provided according to one embodiment.

In some embodiments, the algorithm includes consideration of value, one or more preset thresholds, and/or one or more priority overrides. Value is a derived measure based on the price associated with the campaign, e.g., on a per impression or per click basis. In one embodiment, value includes the price of serving the advertisement, or generating a click on the advertisement, versus the profit there from. In addition, the value measure according to one embodiment includes consideration of the specificity of the campaign targeting, the start date of the advertisement, and/or the total number of impressions associated with the campaign. For example, value is greater according to one embodiment for advertisements using a means for the end user 140 to indicate interest, e.g., by clicking on a link in the advertisement.

One or more preset thresholds may apply to various campaigns. In one embodiment, the preset thresholds are rules governing whether the advertising services provider 155 will be paid by the advertiser for running a given advertisement. Whether a campaign's status is “active,” i.e., not “pending,” “cancelled,” or “paused,” is an applicable threshold according to one embodiment. Frequency caps, such as a minimum time between campaign advertisements, a maximum frequency, and/or a maximum impressions for a given time period (e.g., maximum impressions per hour), are applicable thresholds according to one embodiment. Exclusions, e.g., by content ratings, content category or subcategory, brand proximity, and/or industry proximity, are applicable thresholds according to one embodiment.

Priority overrides are system overrides that force a prioritization based on certain factors according to one embodiment. For example, if a particular campaign has had very few advertisements run, i.e., the campaign is “starved,” the campaign may be forced into a higher priority using such an override. Another example is advertisements that include means for a user to indicate interest; these advertisements get moved to a higher priority according to one embodiment.

In one embodiment, the campaign prioritization 320 is preceded by limiting the plurality of reserved campaigns that satisfy advertisement request parameters to active campaigns, and the algorithm includes value measurement, load balancing and campaign state considerations, and application of preset thresholds. In this example, not all campaigns have to be tested against each step; once a campaign is found that satisfies all considerations, that campaign can be used to fulfill the advertisement request. In various embodiments, the advertisement that is most ready, or the first ready advertisement, is used to fill the advertisement request In another embodiment, if no other advertisements satisfy all the considerations, a run of network advertisement is used to fulfill the request. In yet another embodiment, if no advertisements satisfy all the considerations, no advertisement is run. Once the prioritization is complete, the selected campaign advertisement is delivered 330.

In one embodiment, the advertisement delivery is monitored to determine whether the impression will be counted. For example, an impression count for a campaign is incremented according to one embodiment. This determination is important both for billing purposes, i.e., to know whether to charge for the advertisement, and for understanding campaign state with respect to whether to move on to the next advertisement in a sequence of advertisements for an end user 140. In addition, whether an impression is counted is important to the forecasting model and process with respect to predicting how much advertising inventory to sell to accommodate incoming advertisement requests. In one embodiment, the time an advertisement was sent, or a start time, e.g., for a video advertisement, is known. The end time for video advertisements may also be known according to one embodiment. In addition, a report is received from the service provider 130 regarding whether the advertisement was delivered according to one embodiment.

Process Flow

Reference now is made to FIG. 4, which illustrates a process flow between the modules and entities for practicing the present invention according to one embodiment. On a recurring basis, one or more adverting agencies 135 interact 405 with the campaign module 110, e.g., reserving, reviewing, and booking advertising campaigns. In one embodiment, the interaction is via an advertiser interface to the campaign module 110. Advertisers create an advertising campaign by choosing one or more segments or microcells of users they would like to target with one or more particular advertisement(s) according to one embodiment. Advertisers choose the segment that best represents the type of users who are most likely consumers of their product or service. For products or services that have wide applicability, the advertiser may choose to target multiple segments with a particular advertisement. In the segment model, the advertiser may choose the number of advertisements to send to the users of various segments.

Advertising campaigns are stored 410 to data storage 125. In addition, stored fulfillment history information from data storage 125 is pushed 410 to the campaign module 110 for review 405 by the advertising agency 135 according to one embodiment.

Similarly, one or more service providers 130 interact 415 with the inventory module 105, e.g., providing end user 140 data and content management functionality. The service provider 130 monitors and audits advertisements and campaigns according to one embodiment, and may provide information about a campaign to an advertiser in real time. In one embodiment, the interaction is via a service provider interface to the inventory module 105. End user and content data are stored 420 to data storage 125. In addition, stored fulfillment history information from data storage 125 is pushed 420 to the inventory module 105 for review 415 by the service provider 130 according to one embodiment.

When an advertisement request is received 425 at a delivery engine 145 via a media interface 150, the delivery engine 145 interacts 430 with the fulfillment module 115 to fulfill the request according to one embodiment. The delivery engine 145 initially forwards the advertisement request to the fulfillment module 115.

The fulfillment module 115, using the methods described herein, matches the advertisement request to a campaign. Specifically, the fulfillment module 115 associates information received with the advertisement request with stored data, e.g., user information and content data, by pulling 435 the data from data storage 125. In one embodiment, the information received includes or provides a means for determining information about the end user 140 that is verifiable and that the end user 140 has granted permission to use. In addition, the fulfillment module 115 performs an algorithm to match the data to campaign targeting attributes, prioritize the campaigns, and select a campaign for delivery.

The fulfillment module 115 then provides a response 430 to the delivery engine 145 indicating a matching advertisement name according to one embodiment. The delivery engine 145 sends 440 the named advertisement, pulled 445 from cache 160 or from data storage 125, to the end user 140, and the media interface 150 inserts the advertisement within the content associated with the advertisement request.

Upon delivery completion, the end user 140, or media interface 150, according to various embodiments, returns 425 an indication to delivery engine 145 regarding the impression status of the campaign, which is forwarded 430 to the fulfillment module 115 and stored 435 to data storage 125 according to one embodiment. The campaign module 110 and inventory module 105 then include updated data reflecting the above-described advertisement request. For inventory, campaign reservation, and forecasting purposes, a count for the segment(s) or microcell(s) affected by the updated data are incremented accordingly.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the descriptions herein are described in a software content, it is noted that in various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Further, the features and advantages described in the specification provide a beneficial use to those making use of a system and method as described in the embodiments herein. For example, a user is provided mechanisms, e.g., by receiving and/or transmitting control signals, to control access to particular information described herein. Further, these benefits accrue regardless of whether all or portions of components, e.g., server systems, to support their functionality are located locally or remote relative to the end user.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to a memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of embodiments of the present invention. This was done merely for convenience and to give a general sense of the embodiments of the present invention. This description should be read to include one or at least one and the singular also includes the plural unless it is obvious that it is meant otherwise.

Upon reading this disclosure, those of skill in the art will appreciate still additional alternative structural and functional designs for a system and a process for a matching engine to query relevant documents, which may include a signature generation and relevance detection through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of providing targeted advertising to an end user, comprising:
receiving an advertisement request, wherein the advertisement request comprises advertisement selection data;
combining end user information with the advertisement selection data, wherein the end user information comprises verifiable information the end user has granted permission to use;
identifying one or more campaigns with targeting attributes aligned with the combined end user information and advertisement selection data; and
fulfilling the advertisement request with a selected of the one or more campaigns.

2. The method of claim 1, wherein the advertisement selection data comprises user identification information.

3. The method of claim 1, wherein the user identification information is associated with the verifiable information the end user has granted permission to use.

4. The method of claim 1, wherein the selected of the one or more campaigns is targeted to the end user.

5. The method of claim 1, wherein the advertisement selection data comprises content identification information.

6. The method of claim 5, wherein the content identification information is associated with stored content type and content category information.

7. The method of claim 1, further comprising storing the advertisement selection data.

8. The method of claim 1, wherein the end user granted permission to use the verifiable information by agreeing to service provider contract terms.

9. The method of claim 1, wherein the end user granted permission to use the verifiable information by explicitly disclosing the verifiable information to a service provider.

10. The method of claim 1, wherein the end user granted permission to use the verifiable information by explicitly disclosing the verifiable information to a third party.

11. The method of claim 9, wherein the verifiable information is confirmed by a primary user associated with the service provider.

12. The method of claim 1, wherein the one or more campaigns with targeting attributes aligned with the combined end user information and advertisement selection data comprise all campaigns with at least one targeting attribute aligned with at least one of the combined end user information and advertisement selection data.

13. The method of claim 1, wherein the identifying of the one or more campaigns comprises identifying at least one user segment.

14. The method of claim 1, wherein the identifying of the one or more campaigns comprises identifying at least user microcell.

15. The method of claim 1, further comprising:
mapping the advertisement request to a hyperdimensional array comprising a plurality of intersecting dimension planes, each dimension plane comprising a plurality of attribute rows, wherein the attribute rows intersect to define a plurality of contiguous, non-overlapping microcells, wherein the advertisement request fits into a selected microcell defined by a unique intersection of the attribute rows consisting of the combined end user information and advertisement selection data.

16. The method of claim 1, further comprising incrementing an impression count for the selected of the one or more campaigns.

17. The method of claim 16, wherein the impression count informs a forecasting model.

18. A computer program product for providing targeted advertising to an end user, the computer program product comprising:
a computer-readable medium; and
computer program code, coded on the medium, for:
receiving an advertisement request, wherein the advertisement request comprises advertisement selection data;
combining end user information with the advertisement selection data, wherein the end user information comprises verifiable information the end user has granted permission to use;
identifying one or more campaigns with targeting attributes aligned with the combined end user information and advertisement selection data; and
fulfilling the advertisement request with a selected of the one or more campaigns.

19. The computer program product of claim 18, wherein the advertisement selection data comprises user identification information.

20. The computer program product of claim 18, wherein the user identification information is associated with the verifiable information the end user has granted permission to use.

21. The computer program product of claim 18, wherein the selected of the one or more campaigns is targeted to the end user.

22. The computer program product of claim 18, wherein the one or more campaigns with targeting attributes aligned with the combined end user information and advertisement selection data comprise all campaigns with at least one targeting attribute aligned with at least one of the combined end user information and advertisement selection data.

23. The computer program product of claim 18, further comprising computer program code, coded on the medium, for:
mapping the advertisement request to a hyperdimensional array comprising a plurality of intersecting dimension planes, each dimension plane comprising a plurality of attribute rows, wherein the attribute rows intersect to define a plurality of contiguous, non-overlapping microcells, wherein the advertisement request fits into a selected microcell defined by a unique intersection of the attribute rows consisting of the combined end user information and advertisement selection data.

24. The computer program product of claim 18, further comprising computer program code, coded on the medium, for incrementing an impression count for the selected of the one or more campaigns.

25. The computer program product of claim 24, wherein the impression count informs a forecasting model.

26. A system for providing targeted advertising to an end user, comprising:
a means for receiving an advertisement request, wherein the advertisement request comprises advertisement selection data;
a means for combining end user information with the advertisement selection data, wherein the end user information comprises verifiable information the end user has granted permission to use;
a means for identifying one or more campaigns with targeting attributes aligned with the combined end user information and advertisement selection data; and
a means for fulfilling the advertisement request with a selected of the one or more campaigns.

27. The system of claim 26, wherein the advertisement selection data comprises user identification information.

28. The system of claim 26, wherein the user identification information is associated with the verifiable information the end user has granted permission to use.

29. The system of claim 26, wherein the selected of the one or more campaigns is targeted to the end user.

30. The system of claim 26, further comprising means for incrementing an impression count for the selected of the one or more campaigns.

31. The system of claim 26, wherein the impression count informs a forecasting model.

32. A system for providing targeted advertising to an end user, comprising:
a delivery module for receiving advertisement requests and streaming advertisements;
a data store for storing user information, content information, advertising inventory, and user history; and
a fulfillment module for matching the advertisement requests to the advertising inventory on a per user basis.
